(19) United States
(12) Patent Application Publication
(10) Pub. No.: US 2005/0181181 A1
(43) Pub. Date: Aug. 18, 2005

(54) Method of multi-axial crystalline thermoplastic coating of composite structures

(76) Inventors: Don DiMarzio, Northport, NY (US); Charles Weizenecker, Stony Brook, NY (US); Steve Chu, Ronkonkoma, NY (US); Dom Anton, Smithtown, NY (US)

Correspondence Address: DALLAS OFFICE OF FULBRIGHT & JAWORSKI L.L.P., 2200 ROSS AVENUE, SUITE 2800, DALLAS, TX, 75201-2784, US

(21) Appl. No.: 10/957,233

(22) Filed: Oct. 1, 2004

Related U.S. Application Data
(62) Division of application No. 10/445,238, filed on May 23, 2003.

(51) Int. Cl. B32B 1/00

(52) U.S. Cl. 428/174

(57) ABSTRACT

A method for thermoplastic coating composite structures includes applying a crystalline crystalline multi-axially oriented thermoplastic layer onto a working surface of a tool. A layer of composite material is applied onto the crystalline crystalline multi-axially oriented thermoplastic layer, and the crystalline crystalline multi-axially oriented thermoplastic layer and the layer of composite material are cocured at a specific temperature and pressure in an autoclave. The softening temperature of the crystalline crystalline multi-axially oriented thermoplastic layer is not substantially greater than the curing temperature of the composite material.

### TECHNICAL FIELD OF THE INVENTION

This invention relates generally to the field of materials construction and, more specifically, to a method of multi-axial crystalline thermoplastic coating of composite structures.

### BACKGROUND OF THE INVENTION

Composite structures are desirable in many industries for many applications. The aerospace industry, for example, uses composite structures extensively because, among other desirable attributes, composites have high strength-to-weight ratios. Because of the ever increasing use of composite structures throughout industry, manufacturers are continually searching for better and more economical ways of fabricating composite structures.

Composite structures applied to the exterior of ships and aircraft can experience significant degradation and damage due to attack from environmental exposure and erosion. In this regard, such structures are constantly subjected to oxidation, moisture, fouling, salt-spray, UV radiation, chemicals, and high and low temperatures, among other things, that can cause such structures to experience significant degradation and damage over time. As a consequence, such structural components must be constantly repaired or replaced to prevent the possibility that a given vessel or aircraft will be damaged permanently, if not destroyed.

To attempt to prevent the damage caused by fatigue and environmental exposure on such composite and metallic components, a variety of coating agents and methods of applying the same to such components have been developed to improve their durability.

### SUMMARY OF THE INVENTION

A method for thermoplastic coating composite structures includes applying a crystalline multi-axially oriented thermoplastic layer onto a working surface of a tool. A layer of composite material is applied onto the crystalline multi-axially oriented thermoplastic layer, and the crystalline multi-axially oriented thermoplastic layer and the layer of composite material are cocured at a specific temperature and pressure in an autoclave. The softening temperature of the crystalline multi-axially oriented thermoplastic layer is not substantially greater than the curing temperature of the composite material.

A technical advantage of certain embodiments of the present invention includes improved conforming of the thermoplastic to a complex or otherwise non-flat shape of the working surface of the tool, while maintaining a curing temperature low enough so as to not cause damage to the co-cured composite layer.

Another technical advantage of certain embodiments of the present invention includes that the crystalline multi-axially oriented thermoplastic layer imparts a more equalized tensile strength to the composite structure. Crystalline thermoplastics also exhibit low water and gas permeability and high resistance to erosion and wear.

Yet another technical advantage of certain embodiments of the present invention includes improved uniformity in the texture and thickness of the thermoplastic coating.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIGS. 1A-1D are block diagrams illustrating a method for crystalline multi-axial thermoplastic coating for a composite structure in accordance with one embodiment of the present invention; and

FIG. 2 is a flowchart illustrating a method for crystalline multi-axial thermoplastic coating for a composite structure in accordance with one embodiment of the present invention.

### DETAILED DESCRIPTION OF THE INVENTION

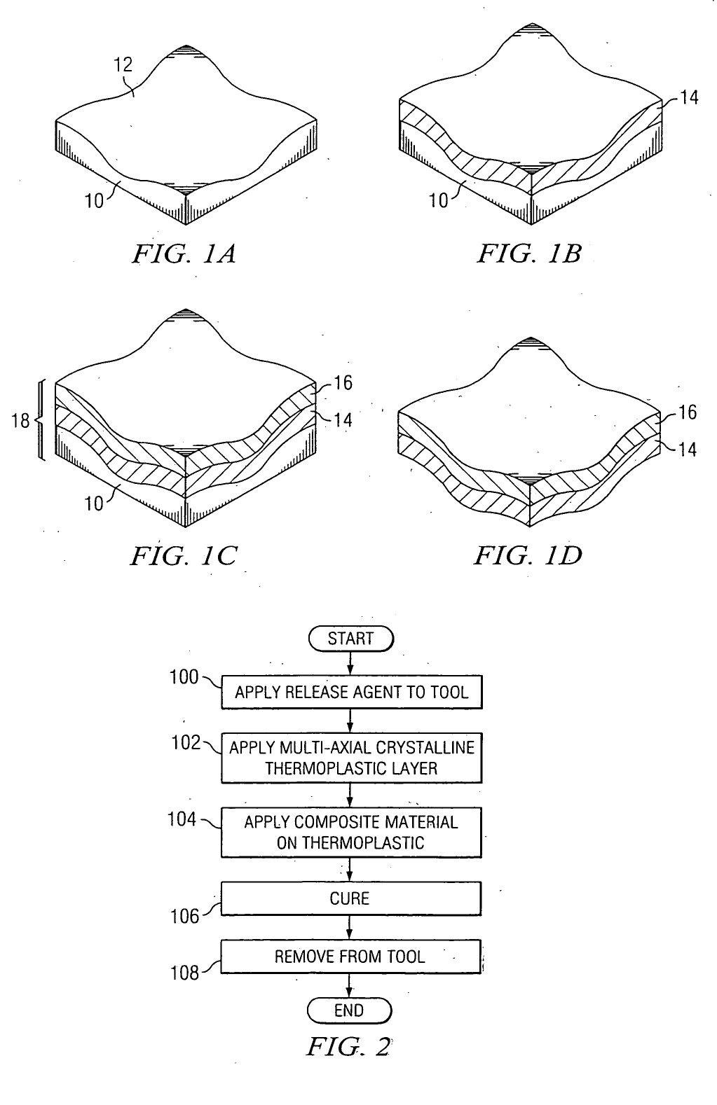

FIGS. 1A-1D are block diagrams illustrating a method for multi-axial thermoplastic coating of composite structures in accordance with one embodiment of the present invention. FIG. 1A illustrates a metal mold or “tool” 10 having a working surface 12 in accordance with one embodiment of the present invention. Working surface 12 reflects the desired shape and/or contours of the outer surface of a final composite structure and may be formed from any suitable material, such as aluminum or steel. However, tool 10 may be formed from other suitable materials, such as ceramic. Working surface 12 may be substantially flat or may comprise compound curvatures or otherwise be non-flat. In a particular embodiment, working surface 12 is coated with Frekote™, Teflon™, or another suitable release coating (not explicitly shown).

FIG. 1B illustrates a thermoplastic layer 14 applied onto the working surface 12 of tool 10 in accordance with one embodiment of the present invention. In a particular embodiment, layer 14 comprises an extruded thermoplastic film. Extruded thermoplastic films may be uniaxial or multi-axial. Uniaxial films have a molecular orientation in one predominant direction and multi-axial films have molecular orientation in two or more directions. Uniaxial films often have higher tensile strength and tear resistance in a direction parallel to the direction of the molecular orientation, but may have lower tensile strength and tear more easily transverse to the orientation. A crystalline multi-axially oriented thermoplastic layer, such as that described in U.S. Pat. No. 6,132,668, may have a more equalized tensile strength. In one embodiment, layer 14 comprises a crystalline multi-axially oriented thermoplastic layer. In a particular embodiment, layer 14 comprises an extruded film of liquid crystal polymer (“LCP”) having a molecular orientation in two directions (a “biaxially-oriented LCP” or “biaxial LCP”).

A process of heating the thermoplastic coating together with the composite may be termed “co-curing.” As described in more detail below in reference to FIGS. 1C and 1D, crystalline multi-axially oriented thermoplastic layer 14 may, in accordance with one embodiment of the present invention, be co-cured with a composite layer 16. The teachings of the present invention recognize that heating a thermoplastic-coated composite material to a temperature at or near a softening temperature of the thermoplastic layer may have the desirable result of causing the thermoplastic layer to better conform to the shape of the composite surface and to result in a thermoplastic coating that has a more uniform texture and thickness. This effect may be especially pronounced wherein the shape of the desired composite includes complex curves. However, many thermoplastics have a softening temperature that is substantially greater than the curing temperature of the composite material. (“Softening temperature,” as used herein, means the temperature at which the polymer structure of a thermoplastic becomes substantially disordered.) Heating the thermoplastic-coated composite material to a temperature substantially greater than the curing temperature of the composite may result in heat-induced damage to the composite layer.

The teachings of the present invention recognize that a crystalline multi-axially oriented thermoplastic layer 14 having a softening temperature not substantially greater than the curing temperature of the composite allows for the layer 14 to adhere to the composite layer 16 and to conform to a complex or otherwise non-flat shape of working surface 12 during curing, while maintaining a curing temperature low enough so as to not cause damage to the composite layer 16. “Substantially” in this context means about 5.5° C. In a particular embodiment, layer 14 may comprise Vectran™ biaxially-oriented liquid crystal polymer with a melting temperature of about 428 to 446° C. and a softening temperature of about 110° C. to 120° C., available from Foster-Miller, Inc. In a particular embodiment, layer 14 may have a thickness of approximately 0.002-0.003 inches. The softening temperature and the thickness of the layer 14 may suitably vary in accordance with various embodiments of the present invention.

At FIG. 1C, a layer 16 of composite material is applied by means of prepreg, wet lay-up, or other suitable methods onto the thermoplastic layer 14. The composite material may be comprised of graphite or fiberglass reinforced epoxy or other suitable materials. The composite/coating/tool assembly 18 is then cured using an oven, autoclave, or other suitable device. In, a particular embodiment wherein crystalline multi-axially oriented thermoplastic layer 14 has a softening temperature of about 110° C. to 120° C., the curing process may be conducted at a temperature of about 177° C. and at a pressure of about 40-50 psi. In a particular embodiment, the curing process may comprise an autoclave vacuum bag process using either a bleed or no-bleed curing cycle.

At FIG. 1D, upon completion of curing, layer 16 of composite material and thermoplastic layer 14 are removed from tool 10. Thermoplastic layer 14 may then form a protective outer surface of the composite layer 16, and composite layer 16 together with thermoplastic layer 14 may then be suitably affixed to the outer surface of a vessel or aircraft or otherwise suitably employed. In particular embodiments, an adhesive (not explicitly shown) may be applied onto the thermoplastic layer 14 before applying layer 16 of composite material. In yet another embodiment, the composite-facing side of thermoplastic layer 14 may be mechanically abraded before or after application of layer 14 onto tool 10. The adhesive and/or mechanical abrasion may increase a bond between thermoplastic layer 14 and composite layer 16, thereby, in particular embodiments, increasing the strength of the structure comprising layers 14 and 16 and further increasing the ease with which the thermoplastic-covered and cured composite material may be removed from tool 10.

FIG. 2 is a flowchart illustrating a method for thermoplastic coating of a composite structure in accordance with one embodiment of the present invention. Beginning with step 100, a release agent such as Teflon™ is applied to the working surface 12 of tool 10.

Proceeding to step 102, biaxial LCP or another suitable crystalline multi-axially oriented thermoplastic layer 14 is applied onto the working surface 12 of tool 10. At step 104, a layer 16 of composite material is applied onto the thermoplastic layer 14. Thermoplastic layer 14 and composite material layer 16 are then co-cured at step 106. Finally, at step 108, thermoplastic layer 14 and composite material layer 16 are removed from the tool 10, resulting in a crystalline multi-axially oriented thermoplastic-coated composite structure.

Although an embodiment of the invention and its advantages are described in detail, a person skilled in the art could make various alterations, additions, and omissions without departing from the spirit and scope of the present invention as defined by the appended claims.

1-13. (canceled)

14. A composite structure, comprising:
a layer of composite material; and
a crystalline multi-axially oriented liquid crystal polymer layer coating the layer of composite material.

15. The composite structure of claim 14, further comprising an adhesive applied between the crystalline multi-axially oriented liquid crystal polymer layer and the layer of composite material.

16. The composite structure of claim 14, wherein the crystalline multi-axially oriented liquid crystal polymer layer comprises a biaxially-oriented thermoplastic layer.

17. The composite structure of claim 14, wherein the crystalline multi-axially oriented liquid crystal polymer layer has a softening temperature of about 110° C. to 120° C.

18. The composite structure of claim 14, wherein the composite has a curing temperature of about 177° C.

19. The composite structure of claim 14, wherein the composite structure is not flat.
